(19) United States
(12) Patent Application Publication
(10) Pub. No.: US 2025/0112230 A1
(43) Pub. Date: Apr. 3, 2025

(54) CELL STRUCTURE FOR SECONDARY BATTERIES

(71) Applicant: Apple Inc., Cupertino, CA (US)

(72) Inventors: Jian Hong, Cupertino, CA (US); Jinjun Shi, San Jose, CA (US)

(21) Appl. No.: 18/890,479

(22) Filed: Sep. 19, 2024

Related U.S. Application Data
(60) Provisional application No. 63/541,552, filed on Sep. 29, 2023.

(51) Int. Cl. H01M 4/38; H01M 4/02; H01M 4/04; H01M 4/36; H01M 10/04; H01M 50/491

(52) U.S. Cl. CPC H01M 4/382; H01M 4/0404; H01M 4/366; H01M 4/386; H01M 10/0431; H01M 50/491; H01M 2004/021; H01M 2004/027

(57) ABSTRACT

A battery pre-lithiation assembly includes an anode having first holes and a cathode having second holes. The first holes and the second holes are configured to enable an electrolyte to pass therethrough. Further, the first holes and the second holes are configured to enable movement of Li+ ions associated with the lithium metal during a pre-lithiation process. The lithium metal may be coated on the anode (e.g., on active material of the anode), or the lithium metal may correspond to at least one lithium metal electrode, such as first and second lithium metal electrodes disposed on opposing sides of an electrode stack (e.g., a jelly roll) including the anode, the cathode, and a separator.

### CROSS-REFERENCE TO RELATED APPLICATIONS

This application claims priority to U.S. Provisional Application No. 63/541,552, filed Sep. 29, 2023, entitled “Cell Structure for Secondary Batteries,” which is incorporated by reference herein in its entirety for all purposes.

### BACKGROUND

The present disclosure relates generally to batteries, such as secondary or rechargeable batteries (e.g., lithium-ion batteries), and more specifically to a structure and pre-lithiation process of such batteries.

Certain batteries, such as those described above, may undergo a pre-lithiation process causing Li+ ions to react with an anode of the battery during formation of the battery (e.g., prior to using the battery for powering a load). Pre-lithiation processes may employ the redox reaction to reduce or mitigate initial active lithium loss that occurs during cycling stages (e.g., early cycling stages) of the battery, improve local voltage uniformity, and/or maintain cell stability and performance. Unfortunately, traditional pre-lithiation processes may be cumbersome, expensive, inadequate, and/or ineffective. Accordingly, it is now recognized that improved systems and methods are desired.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a battery pre-lithiation assembly includes a lithium metal electrode, an anode, and a cathode. The anode includes first holes configured to enable an electrolyte to pass therethrough, and configured to enable movement of Li+ ions associated with the lithium metal electrode during a pre-lithiation process. The cathode includes second holes configured to enable the electrolyte to pass therethrough, and configured to enable movement of the Li+ ions associated with the lithium metal electrode during the pre-lithiation process.

In another embodiment, a battery pre-lithiation assembly includes an anode coated with lithium metal and having first holes configured to enable an electrolyte to pass therethrough, and configured to enable movement of Li+ ions associated with the lithium metal during a pre-lithiation process. The battery pre-lithiation assembly also includes a cathode having second holes configured to enable the electrolyte to pass therethrough, and configured to enable movement of the Li+ ions associated with the lithium metal during the pre-lithiation process.

In another embodiment, a method of forming a battery cell includes disposing a lithium metal electrode in an enclosure, disposing an anode in the enclosure, and disposing a cathode in the enclosure. The method also includes disposing an electrolyte in the enclosure such that the electrolyte passes through first holes in the anode and second holes in the cathode to form channels enabling movement of Li+ ions (e.g., associated with the lithium metal electrode) within the enclosure and reaction of the Li+ ions with the anode in a pre-lithiation process.

In another embodiment, a method of forming a battery cell includes coating an anode with lithium metal, disposing the anode in an enclosure, and disposing a cathode in the enclosure.

The method also includes disposing an electrolyte in the enclosure such that the electrolyte passes through first holes in the anode and second holes in the cathode to form channels enabling movement of Li+ ions (e.g., associated with the lithium metal) within the enclosure and reaction of the Li+ ion with the anode in a pre-lithiation process.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of an electronic device, according to embodiments of the present disclosure;

FIG. 2 is a schematic perspective view of a battery following pre-lithiation, where the battery is configured to power the electronic device of FIG. 1, according to embodiments of the present disclosure;

FIG. 3 is a schematic view of various types of batteries following pre-lithiation, according to embodiments of the present disclosure;

FIG. 4 is a schematic cross-sectional view of a battery pre-lithiation assembly employed to produce, for example, the battery of FIG. 2, where the battery pre-lithiation assembly includes at least one lithium metal electrode, according to embodiments of the present disclosure;

FIG. 5 is a schematic cross-sectional view of a battery pre-lithiation assembly employed to produce, for example, the battery of FIG. 2, where the battery pre-lithiation assembly includes at least one lithium metal electrode, and the battery pre-lithiation assembly includes mis-alignment between anode holes and cathode holes, according to embodiments of the present disclosure;

FIG. 6A is a schematic cross-sectional view of a layered structure of a cathode of the battery pre-lithiation assembly of FIG. 4 or FIG. 5, according to embodiments of the present disclosure;

FIG. 6B is a schematic cross-sectional view of another layered structure of a cathode of the battery pre-lithiation assembly of FIG. 4 or FIG. 5, according to embodiments of the present disclosure;

FIG. 7 is a schematic view of additional aspects of the battery pre-lithiation assembly of FIG. 4 or FIG. 5 along various stages of producing, for example, the battery of FIG. 2, according to embodiments of the present disclosure;

FIG. 8 is a schematic cross-sectional view of a battery pre-lithiation assembly employed to produce, for example, the battery of FIG. 2, where the battery pre-lithiation assembly includes lithium metal coated on one or more anodes, according to embodiments of the present disclosure;

FIG. 9 is a schematic cross-sectional view of a battery pre-lithiation assembly employed to produce, for example, the battery of FIG. 2, where the battery pre-lithiation assembly includes lithium metal coated on one or more anodes, and the battery pre-lithiation assembly includes mis-alignment between anode holes and cathode holes, according to embodiments of the present disclosure;

FIG. 10 is a schematic cross-sectional view of the battery of FIG. 2, for example, following use of the battery pre-lithiation assembly of FIG. 4 or FIG. 8, according to embodiments of the present disclosure;

FIG. 11 is a schematic cross-sectional view of the battery of FIG. 2, for example, following use of the pre-lithiation assembly of FIG. 5 or FIG. 9, according to embodiments of the present disclosure;

FIG. 12 is a process flow diagram illustrating a method of producing, for example, the battery of FIG. 2 via the battery pre-lithiation assembly of FIG. 4 or FIG. 5, according to embodiments of the present disclosure;

FIG. 13 is a process flow diagram illustrating a method of producing, for example, the battery of FIG. 2 via the battery pre-lithiation assembly of FIG. 8 or FIG. 9, according to embodiments of the present disclosure; and

FIG. 14 is a process flow diagram illustrating a method of producing, for example, the battery of FIG. 2 via the battery pre-lithiation assembly of FIG. 8 or FIG. 9, according to embodiments of the present disclosure.

### DETAILED DESCRIPTION OF SPECIFIC EMBODIMENTS

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on).

This disclosure is directed to batteries, such as secondary or rechargeable batteries (e.g., lithium-ion batteries). More specifically, the present disclosure is directed to a structure and pre-lithiation process of such batteries.

A battery may include, among other features, electrodes (e.g., at least one anode and at least one cathode), a separator, an electrolyte, and an enclosure in which the electrodes, separator, and electrolyte are disposed. In some embodiments, the electrodes and the separator may form a jelly roll, while in other embodiments, the electrodes and the separator may be in a stacked configuration. Further, the electrodes may be electrically coupled with terminals of the battery (e.g., via electrode tabs), where the terminals are configured to be coupled to a load to enable the battery to power the load.

A secondary battery (e.g., rechargeable battery), such as a lithium-ion (Li-ion) battery, may be cycled through various discharging and charging sequences during a lifetime of the battery. Initial active lithium loss may occur in certain of such cycles, which can affect battery stability, performance, and/or energy density. In accordance with the present disclosure, a pre-lithiation process may be administered that introduces a lithium source in a battery pre-lithiation assembly, where the lithium source mitigates initial active lithium loss and improves local voltage uniformity, battery performance, and battery stability, among other technical benefits.

As described in detail with reference to the drawings, the lithium source may include a lithium metal employed as one or more electrodes separate from the anode(s) and the cathode(s), or as a coating on an active material of the anode(s). The lithium source may be disposed in an enclosure, along with the anode, the cathode, the separator, and the electrolyte. In embodiments employing the lithium metal electrode (e.g., as opposed to the lithium metal coating), to initiate the pre-lithiation process, a voltage may be applied to the lithium metal electrode. In embodiments employing the lithium metal coating, a time period for electrolyte aging may be employed to initiate and/or carry out the pre-lithiation process. Holes (e.g., openings) in the anode and the cathode, and pores in the separator, may enable an electrolyte to pass therethrough, which forms channels promoting movement of the Li+ ions associated with or corresponding to the lithium metal source about an interior of an enclosure of the battery pre-lithiation assembly. A redox reaction between the Li+ ions and the anode may occur such that active lithium is transferred to the anode(s), thereby reducing, negating, or otherwise preventing initial active lithium loss and/or local voltage non-uniformity.

As described above and in more detail below, presently disclosed systems and techniques enable improved local voltage uniformity, reduced initial active lithium loss, and improved battery performance, stability, and energy density over traditional systems and techniques. Further, presently disclosed systems and techniques may be less expensive and cumbersome than traditional techniques. It should be noted that, while certain embodiments of the present disclosure are discussed in the context of a lithium-ion (Li-ion) battery, similar systems and techniques may be employed in other batteries with other material compositions. These and other aspects of the present disclosure are described in detail below with reference to the drawings.

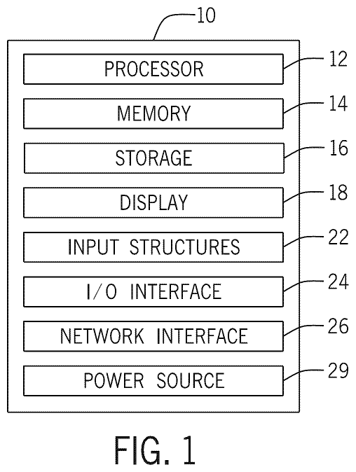

Continuing now with the drawings, FIG. 1 is a block diagram of an electronic device 10, according to embodiments of the present disclosure. The electronic device 10 may include, among other things, one or more processors 12 (collectively referred to herein as a single processor for convenience, which may be implemented in any suitable form of processing circuitry), memory 14, nonvolatile storage 16, a display 18, input structures 22, an input/output (I/O) interface 24, a network interface 26, and a power source 29. The various functional blocks shown in FIG. 1 may include hardware elements (including circuitry), software elements (including machine-executable instructions) or a combination of both hardware and software elements (which may be referred to as logic). The processor 12, memory 14, the nonvolatile storage 16, the display 18, the input structures 22, the input/output (I/O) interface 24, the network interface 26, and/or the power source 29 may each be communicatively coupled directly or indirectly (e.g., through or via another component, a communication bus, a network) to one another to transmit and/or receive signals between one another. It should be noted that FIG. 1 is merely one example of a particular implementation and is intended to illustrate the types of components that may be present in the electronic device 10.

By way of example, the electronic device 10 may include any suitable computing device, including a desktop or notebook computer, a portable electronic or handheld electronic device such as a wireless electronic device or smartphone, a tablet, a wearable electronic device, and other similar devices. In additional or alternative embodiments, the electronic device 10 may include an access point, such as a base station, a router (e.g., a wireless or Wi-Fi router), a hub, a switch, and so on. It should be noted that the processor 12 and other related items in FIG. 1 may be embodied wholly or in part as software, hardware, or both. Furthermore, the processor 12 and other related items in FIG. 1 may be a single contained processing module or may be incorporated wholly or partially within any of the other elements within the electronic device 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may include one or more application processors, one or more baseband processors, or both, and perform the various functions described herein.

In the electronic device 10 of FIG. 1, the processor 12 may be operably coupled with a memory 14 and a nonvolatile storage 16 to perform various algorithms. Such programs or instructions executed by the processor 12 may be stored in any suitable article of manufacture that includes one or more tangible, computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the electronic device 10 to provide various functionalities.

In certain embodiments, the display 18 may facilitate users to view images generated on the electronic device 10. In some embodiments, the display 18 may include a touch screen, which may facilitate user interaction with a user interface of the electronic device 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 22 of the electronic device 10 may enable a user to interact with the electronic device 10 (e.g., pressing a button to increase or decrease a volume level). The I/O interface 24 may enable electronic device 10 to interface with various other electronic devices, as may the network interface 26. In some embodiments, the I/O interface 24 may include an I/O port for a hardwired connection for charging and/or content manipulation using a standard connector and protocol, such as the Lightning connector, a universal serial bus (USB), or other similar connector and protocol. The network interface 26 may include, for example, one or more interfaces for a personal area network (PAN), such as an ultra-wideband (UWB) or a BLUETOOTH network, a local area network (LAN) or wireless local area network (WLAN), such as a network employing one of the IEEE 802.11x family of protocols (e.g., WI-FI), and/or a wide area network (WAN), such as any standards related to the Third Generation Partnership Project (3GPP), including, for example, a 3rd generation (3G) cellular network, universal mobile telecommunication system (UMTS), 4th generation (4G) cellular network, Long Term Evolution (LTE) cellular network, Long Term Evolution License Assisted Access (LTE-LAA) cellular network, 5th generation (5G) cellular network, and/or New Radio (NR) cellular network, a 6th generation (6G) or greater than 6G cellular network, a satellite network, a non-terrestrial network, and so on. In particular, the network interface 26 may include, for example, one or more interfaces for using a cellular communication standard of the 5G specifications that include the millimeter wave (mmWave) frequency range (e.g., 24.25-300 gigahertz (GHz)) that defines and/or enables frequency ranges used for wireless communication. The network interface 26 of the electronic device 10 may allow communication over the aforementioned networks (e.g., 5G, Wi-Fi, LTE-LAA, and so forth).

The network interface 26 may also include one or more interfaces for, for example, broadband fixed wireless access networks (e.g., WIMAX), mobile broadband Wireless networks (mobile WIMAX), asynchronous digital subscriber lines (e.g., ADSL, VDSL), digital video broadcasting-terrestrial (DVB-T) network and its extension DVB Handheld (DVB-H) network, ultra-wideband (UWB) network, alternating current (AC) power lines, and so forth.

The power source 29 of the electronic device 10 may include any suitable source of power, such as a rechargeable lithium polymer (Li-poly) battery and/or an alternating current (AC) power converter. In accordance with the present disclosure, a battery pre-lithiation assembly is employed to produce a battery, such as a secondary or rechargeable battery (e.g., a lithium-ion battery). The pre-lithiation assembly includes a lithium source (e.g., a lithium metal) employed as one or more electrodes separate from one or more anodes and one or more cathodes of the battery, or as a coating on an active material of the anode(s). Holes (e.g., openings) in the anode(s) and the cathode(s), and pores in one or more separators, may enable an electrolyte to pass therethrough, which forms channels promoting movement of Li+ ions associated with or corresponding to the lithium metal source about an interior of an enclosure of the battery pre-lithiation assembly. A redox reaction between the Li+ ions and the anode(s) may occur such that active lithium is transferred to the anode(s), thereby reducing, negating, or otherwise preventing initial active lithium loss and/or local voltage non-uniformity. In this way, presently disclosed systems and techniques enable improved local voltage uniformity, reduced initial active lithium loss, and improved battery performance, stability, and energy density over traditional systems and techniques. Further, presently disclosed systems and techniques may be less expensive and cumbersome than traditional techniques. These and other aspects of the present disclosure are described in detail below with reference to the drawings.

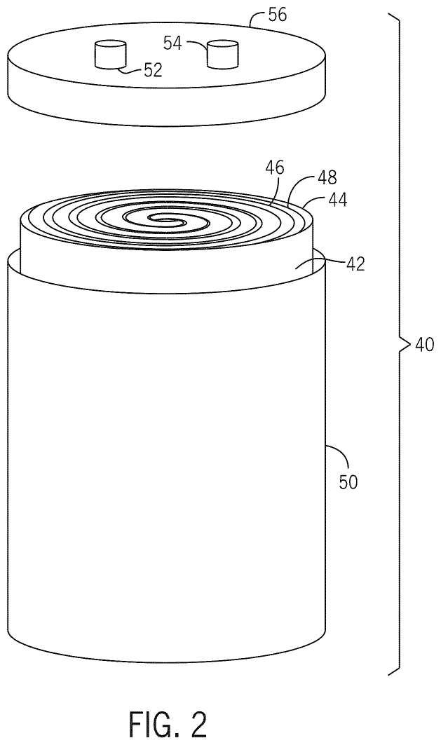

FIG. 2 is a schematic perspective view of an embodiment of a battery 40 (e.g., lithium-ion battery) including a jelly roll 42 having at least one anode 44, at least one cathode 46, and at least one separator 48 (e.g., porous separator) disposed between the anode 44 and the cathode 46. The jelly roll 42 and an electrolyte of the battery 40 are disposed in an enclosure 50. Further, the jelly roll 42 is electrically coupled with a first terminal 52 (e.g., positive terminal) of the battery 40 and a second terminal 54 (e.g., negative terminal) of the battery 40, where the first terminal 52 and the second terminal 54 are configured to be coupled to a load to enable the battery 40 to power the load. Although presently disclosed embodiments are directed to the battery 40 including the jelly roll 42, it should be understood that similar techniques may be employed in the context of a battery having stacked electrodes. Further, while the first terminal 52 and the second terminal 54 are illustrated as extending from or through a lid 56 configured to be coupled with (or forming a part of) the enclosure 50, other arrangements are also possible.

Prior to the battery 40 of FIG. 2 being used to power a load, a pre-lithiation process is administered via a battery pre-lithiation assembly having much of the same componentry as the battery 40. As previously described, the battery pre-lithiation assembly and corresponding processes may be relatively inexpensive and may reduce initial active lithium loss and improve local voltage uniformity, performance, stability, and energy density of the battery 40 over traditional systems and techniques. Various embodiments of the battery pre-lithiation assembly and processes corresponding to the pre-lithiation assembly, in accordance with the present disclosure, are described in detail below.

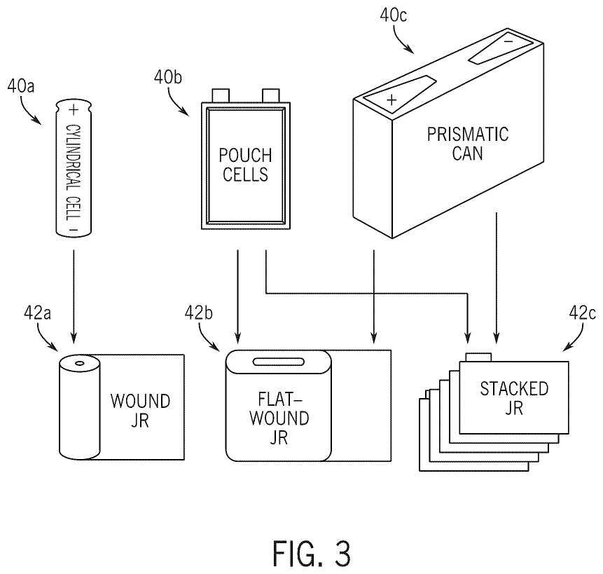

FIG. 3 is a schematic view of various embodiments (e.g., types) of batteries following pre-lithiation. For example, while certain aspects of pre-lithiation described in detail below may refer back to the battery 40 in FIG. 2, it should be understood that some or all of such features may be employed in some or all of the various embodiments or types of batteries illustrated in FIG. 3. FIG. 3 includes, for example, a cylindrical battery cell 40a, a pouch battery cell 40b, and a prismatic battery cell 40c. As shown in FIG. 3, the cylindrical battery cell 40a may include a wound jelly roll 42a, the pouch battery cell 40b may include a flat-wound jelly roll 42b or a stacked electrode assembly 42c (referred to in certain instances as a stacked jelly roll), and the prismatic battery cell 40c may include the flat-wound jelly roll 42b or the stacked electrode assembly 42c (referred to in certain instances as a stacked jelly roll).

In certain embodiments employing the wound jelly roll 42a, the lithium metal of the pre-lithiation assemblies and/or processes described below may be coated on the anode of the wound jelly roll 42a. In certain embodiments employing the flat wound jelly roll 42b, the lithium metal of the pre-lithiation assemblies and/or processes described below may be coated on the anode of the wound jelly roll 42b, a center of the wound jelly roll 42b, or opposing sides of the flat would jelly roll 42b. In certain embodiments employing the stacked electrode assembly 42c (e.g., stacked jelly roll), the lithium metal of the pre-lithiation assemblies and/or processes described below may be coated on the anode or on the opposite side of the stacked electrode assembly 42c (e.g., stacked jelly roll). It should be understood that certain or all of the pre-lithiation features (e.g., assemblies, methods, processes, etc.) described in detail below with reference to later drawings may be employed in certain or all of the embodiments (e.g., types) of battery cells 40a, 40b, 40c illustrated in FIG. 3. However, for simplicity, reference is made below to the battery 40 and the jelly roll 42.

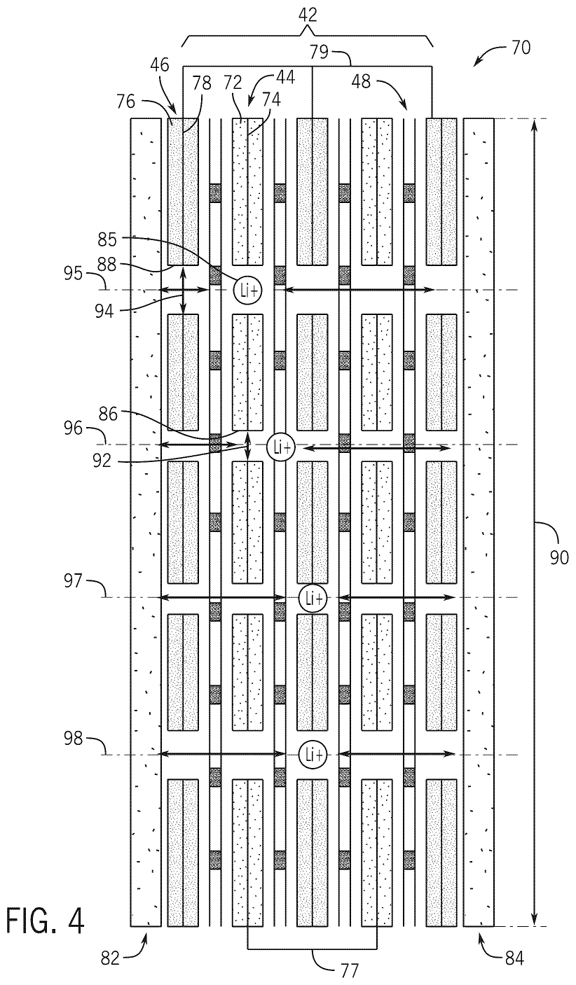

FIG. 4 is a schematic cross-sectional view of an embodiment of a battery pre-lithiation assembly 70 employed to produce the battery 40 of FIG. 2, the battery pre-lithiation assembly 70 including at least one lithium metal electrode, such as first and second lithium metal electrodes 82, 84. The first and second lithium metal electrodes 82, 84 act as a source of Li+ ions 85 for the battery pre-lithiation assembly 70 (e.g., after or while applying a voltage to the lithium metal electrodes 82, 84). For example, the lithium metal electrodes 82, 84 may be soluble as an ion. While the illustrated embodiment includes the first and second lithium metal electrodes 82, 84, in other embodiments, only one lithium metal electrode is employed (e.g., extending about the jelly roll 42). In certain embodiments, reference numerals 82 and 84 may denote different portions of one lithium metal electrode. Further, in certain embodiments, the anode 44, the cathode 46, or both face the lithium metal electrode or a number of lithium metal electrodes including the lithium metal electrode.

As shown in FIG. 4, the battery pre-lithiation assembly 70 includes many of the same or similar features as the battery 40 in FIG. 2, including the anode 44, the cathode 46, and the separator 48. The anode 44 includes a first active material 72 disposed on (e.g., coated on) a first current collector foil 74 (e.g., having a copper material), and the cathode 46 may include a second active material 76 disposed on (e.g., coated on) a second current collector foil 78 (e.g., having an aluminum material). In embodiments where multiple instances of the anode 44 and multiple instances of the cathode 46 are employed, such as in a stacked configuration, an anode current collector 77 is coupled to the first current collector foil 74 of each anode 44, and a cathode current collector 79 is coupled to the second current collector foil 78 of each cathode 46.

Further, as shown in FIG. 4, first holes 86 are formed in the anode 44 and second holes 88 are formed in the cathode 46. The first holes 86 and the second holes 88 may be aligned (e.g., with respect to a height direction 90), as shown, or misaligned in other embodiments. Each first hole 86 may include a first size dimension 92 (e.g., first cross-sectional diameter) of approximately 35 to 1000 micrometers, 100 to 800 micrometers, 200 to 600 micrometers, or 300 to 400 micrometers. Further, each second hole 88 may include a second size dimension 94 (e.g., second cross-sectional diameter) of approximately 35 to 1000 micrometers, 100 to 800 micrometers, 200 to 600 micrometers, or 300 to 400 micrometers. In certain embodiments, the first size dimension 92 of each first hole 86 may be similar to (e.g., within +/−3% of), or the same as, the second size dimension 94 of each second hole 88. In other embodiments, the first size dimension 92 may substantially deviate from the second size dimension 94 (e.g., by greater than +/−3%). In general, the first holes 86 and the second holes 88 are sized to enable an electrolyte to pass therethrough, forming channels that promote movement of the Li+ ions 85 therethrough and about the battery pre-lithiation assembly 70, such that the Li+ ions 85 react with the anode 44 during the pre-lithiation process. As previously described, the lithium metal electrodes 82, 84 may be the source of the Li+ ions 85. Pores of the separator 48 may also enable the electrolyte and the Li+ ions 85 to pass/move therethrough.

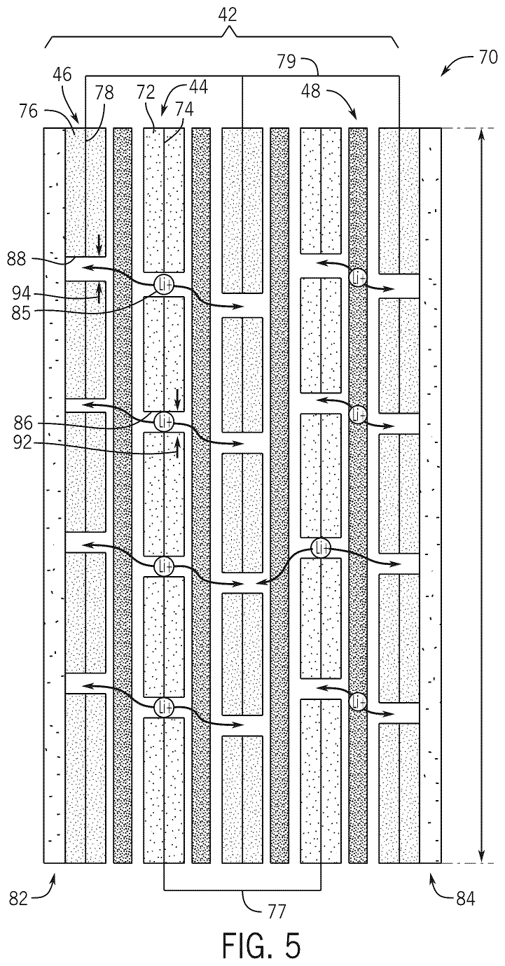

As shown in FIG. 4, the first holes 86 in the anode(s) 44 may be aligned with the second holes 88 in the cathode(s) 46 along the height direction 90 of the battery pre-lithiation assembly 70. For example, as shown in FIG. 4, a first straight line 95 may be drawn or go through a first set of the first holes 86 and the second holes 88, where the first straight line 95 extends transverse to (e.g., perpendicular to) the height direction 90. Likewise, a second straight line 96 may be drawn or go through a second set of the first holes 86 and the second holes 88, a third straight line 97 may be drawn or go through a third set of the first holes 86 and the second holes 88, a fourth straight line 98 may be drawn or go through a fourth set of the first holes 86 and the second holes 88, and so on and so forth, where the second straight line 96, the third straight line 97, and the fourth straight line 98 extend transverse to (e.g., perpendicular to) the height direction 90. As such, the lines 95, 96, 97, 98 traversing through the holes 86, 88 may be parallel to one another. In other embodiments, the first holes 86 in the anode(s) 44 may be mis-aligned with the second holes 88 in the cathode(s) 46 along the height direction 90. For example, FIG. 5 is schematic cross-sectional view of an embodiment of the battery pre-lithiation assembly 70 having the same or similar features illustrated in FIG. 4, except that the first holes 86 of the anode(s) 44 are mis-aligned with the second holes 88 in the cathode(s) 46 along the height direction 90. In FIG. 5, mis-alignment of the first holes 86 and the second holes 88 negates an ability to draw straight lines or enable straight lines to go through the holes 86, 88, similar to those described above with respect to FIG.

4.

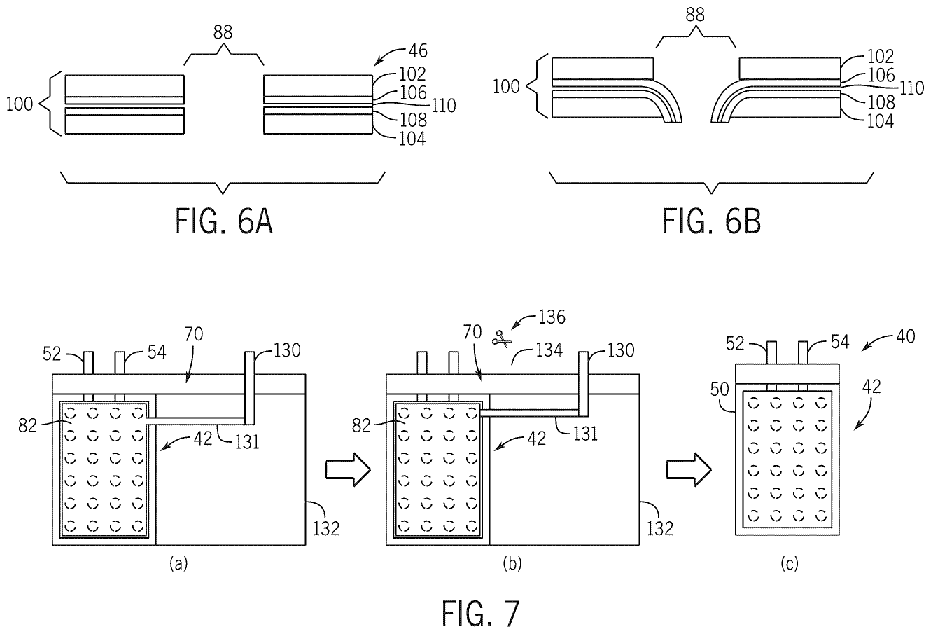

FIGS. 6A and 6B are schematic cross-sectional views of two embodiments of a layered structure 100 of the cathode 46, for example, of the battery pre-lithiation assembly 70 of FIG. 4 or FIG. 5. It should be noted that similar layered structure(s) may be employed for the anode 44 of the battery pre-lithiation assembly 70 of FIG. 4 or FIG. 5. In FIGS. 6A and 6B, the layered structure 100 includes a first cathode active material layer 102, a second cathode active material layer 104, a first metal (e.g., aluminum) foil layer 106, a second metal (e.g., aluminum) foil layer 108, and a plastic layer 110. In certain embodiments, the first metal foil layer 106, the second metal foil layer 108, and the plastic layer 110 may together form the second current collector foil 78 of the cathode 46 described above and illustrated in FIG. 4 or FIG. 5. The first and second cathode active material layers 102, 104 may include, for example, metal oxides such as lithium cobalt oxide, lithium manganese oxide, lithium iron phosphate, or lithium nickel manganese cobalt oxide.

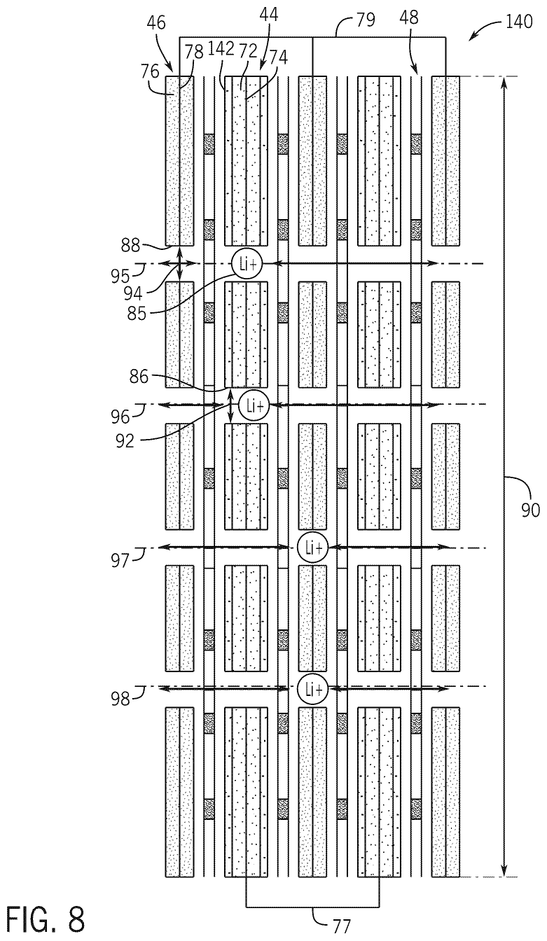

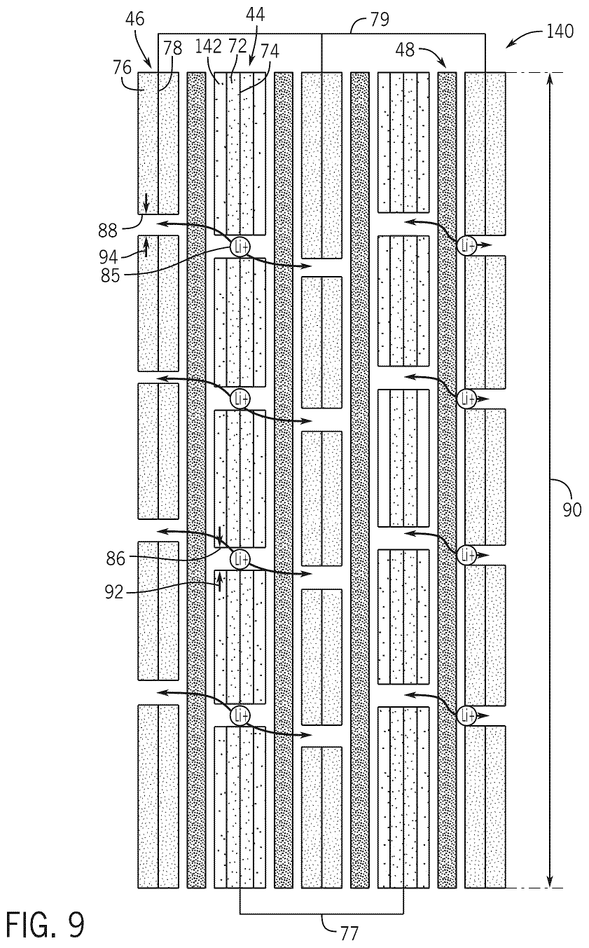

As shown, the first metal foil layer 106, the second metal foil layer 108, and the plastic layer 110 may be disposed between the first cathode active material layer 102 and the second cathode active material layer 104. Further, the plastic layer 110 may be disposed between the first metal foil layer 106 and the second metal foil layer 108. As described above, a similar layered structure may be employed for the anode 44 of FIG. 4 or FIG. 5, except that different materials would be used for the anode active material layers (e.g., carbon-based materials, such as graphite and/or silicon) and the metal foil layers (e.g., copper). In certain embodiments, such as the embodiment described in greater detail with respect to FIGS. 8 and 9, a layered structure of the anode 44 may also include lithium metal coatings on both of the anode active material layers.

As previously described, the cathode may include holes, such as the hole 88 in FIGS. 6A and 6B, formed therethrough. The hole 88 may be generated via laser perforation (e.g., enabling non-contact formation, holes of different shapes and/or sizes, etc.) or mechanical drill (e.g. enabling hole formation at a low cost and high efficiency). The holes in the anode 44 may be formed via the same or similar mechanisms. In FIG. 6B, the layered structure 100 includes bended foil (e.g., the first metal foil layer 106, the second metal foil layer 108, and the plastic layer 110) that covers an edge of the second cathode active material layer 104. In general, the layered structure 100 of the cathode 46 in at least FIG. 6B may reduce or negate metal burring and/or a negative effect associated with metal burring. It should be noted that other types of anodes and/or cathodes not including the layered structure 100 may be employed in the battery pre-lithiation assemblies described by the present disclosure. It should be noted that, in certain embodiments copper or aluminum foils may be employed, while in certain other embodiments, hybrid copper/aluminum foils may be employed. Further, it should be understood that the layered structure 100 in FIGS. 6A and 6B are merely examples of the cathode 46 and that other embodiments of the cathode 46 may be employed. Likewise, while a layered structure similar to the examples in FIGS. 6A and 6B may be employed for the anode 44, other embodiments of the anode 44 may be employed.

FIG. 7 is a schematic view of additional aspects of an embodiment of the battery pre-lithiation assembly 70 of FIG. 4 or FIG. 5 along various stages of producing the battery of FIG. 2. At stage (a), the jelly roll 42 and the lithium metal electrode 82 are disposed in a gas pouch 132 (e.g., enclosure). A voltage applicator 130 is employed to apply a voltage via electrical connection 131 to the lithium metal electrode 82 (and, in embodiments employing multiple lithium metal electrodes, any other lithium metal electrodes employed in the battery pre-lithiation assembly 70, such as the second lithium metal electrode 84 illustrated in FIG. 4 and FIG. 5). At stage (b), the gas pouch 132 is trimmed 134 via a cutter 136, the electrical connection 131 and the voltage applicator 130 are withdrawn, and the lithium metal electrode 82 (or lithium metal electrodes) is removed from the assembly, forming the battery 40 at stage (c). Degassing and side sealing may also be performed at stage (c), such that a portion of the gas pouch 132 illustrated at stages (a) and (b) forms the enclosure 50 of the battery 40.

FIG. 8 is a schematic cross-sectional view of an embodiment of a battery pre-lithiation assembly 140 employed to produce the battery 40 of FIG. 2, where the battery pre-lithiation assembly 140 includes lithium metal layers 142 coated on the anode 44 (e.g., on the anode active material 72). The battery pre-lithiation assembly 140 of FIG. 8 includes many of the same or similar features as the battery pre-lithiation assembly 70 of FIG. 4 and/or FIG. 5. However, the battery pre-lithiation assembly 140 of FIG. 8 includes the lithium metal layers 142 coated on the anode 44 (e.g., as the source of the Li+ ions 85), instead of the lithium metal electrodes 82, 84 of the battery pre-lithiation assembly 70 of FIG. 4 and/or FIG. 5. In FIG. 8, the lithium metal layers 142 may be depleted during the pre-lithiation process corresponding to the battery pre-lithiation assembly 140. Accordingly, unlike in FIGS. 4 and 5, lithium metal need not be removed from the battery pre-lithiation assembly 140 to form the battery 40 of FIG. 2. It should be noted that the layered structure 100 of the cathode 46 of FIGS. 6A and/or 6B may be employed in the battery pre-lithiation assembly 140 of FIG. 8. Likewise, a similar layered structure (but including the lithium metal layers 142 and materials corresponding to the anode) may be employed for the anode 44 of FIG. 8.

As shown in FIG. 8, the first holes 86 in the anode(s) 44 may be aligned with the second holes 88 in the cathode(s) 46 along the height direction 90 of the battery pre-lithiation assembly 140. In other embodiments, the first holes 86 in the anode(s) 44 may be mis-aligned with the second holes 88 in the cathode(s) 46 along the height direction 90. For example, FIG. 9 is schematic cross-sectional view of an embodiment of the battery pre-lithiation assembly 140 having the same or similar features illustrated in FIG. 8, except that the first holes 86 of the anode(s) 44 are mis-aligned with the second holes 88 in the cathode(s) 46 along the height direction 90.

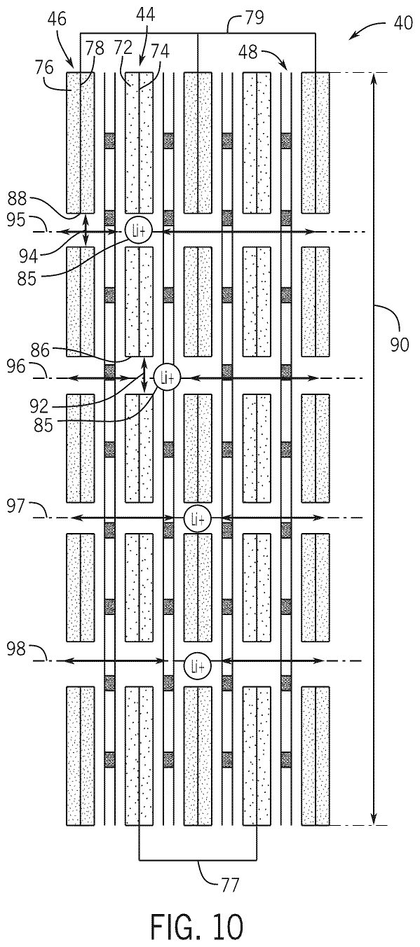

FIG. 10 is a schematic cross-sectional view of an embodiment of the battery 40 of FIG. 2 following use of the battery pre-lithiation assembly 70 of FIG. 4 or the battery pre-lithiation assembly 140 of FIG. 8. As previously described, when using the battery pre-lithiation assembly 70 of FIG. 4, the lithium metal electrodes 82, 84 may be removed from the battery pre-lithiation assembly 70 during production of the battery 40 of FIG. 2. In contract, when using the battery pre-lithiation assembly 140 of FIG. 8, the lithium metal coating 142 may be depleted during the pre-lithiation process such that lithium metal need not be removed during production of the battery 40. That is, the battery 40 of FIGS. 2 and 10 may be produced via either the battery pre-lithiation assembly 70 of FIG. 4 or the battery pre-lithiation assembly 140 of FIG. 8.

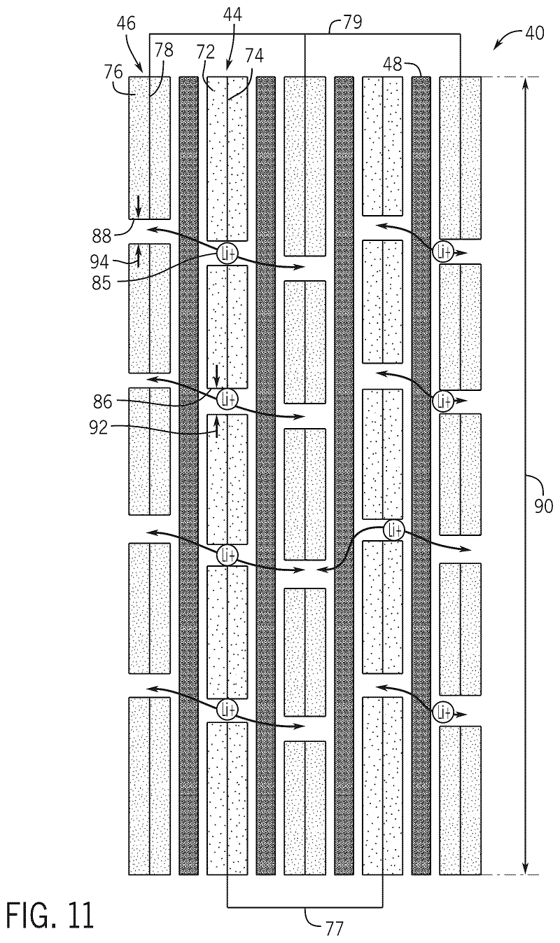

As shown in FIG. 10, the first holes 86 in the anode(s) 44 may be aligned with the second holes 88 in the cathode(s) 46 along the height direction 90 of the battery 40. In other embodiments, the first holes 86 in the anode(s) 44 may be mis-aligned with the second holes 88 in the cathode(s) 46 along the height direction 90. For example, FIG. 11 is schematic cross-sectional view of an embodiment of the battery 40 (i.e., following use of the battery pre-lithiation assembly 70 of FIG. 5 or the pre-lithiation assembly 140 of FIG. 9) having the same or similar features illustrated in FIG. 10, except that the first holes 86 of the anode(s) 44 are mis-aligned with the second holes 88 in the cathode(s) 46 along the height direction 90.

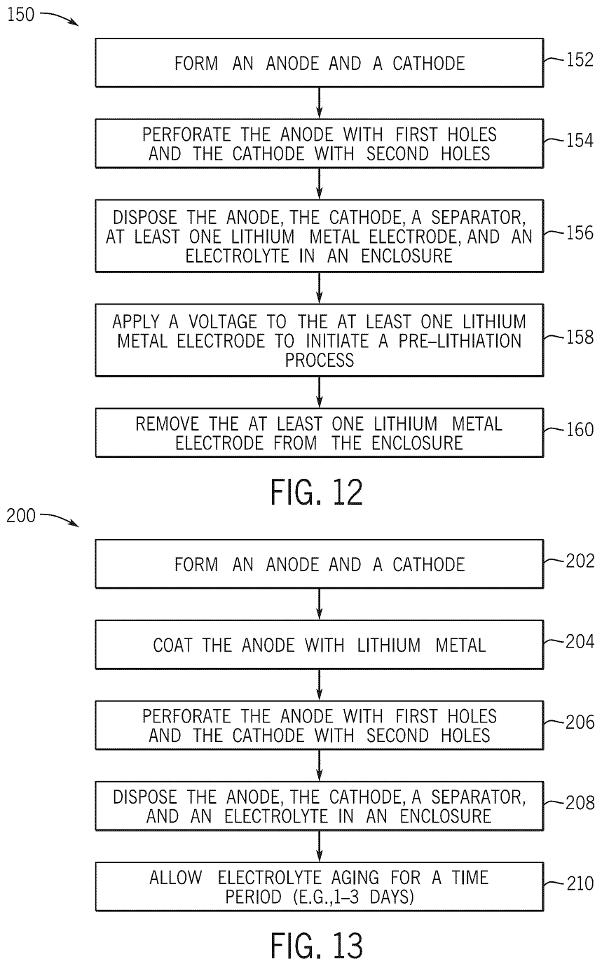

FIG. 12 is a process flow diagram illustrating an embodiment of a method 150 of producing the battery 40 of FIG. 2 via the battery pre-lithiation assembly 70 of FIG. 4 or FIG. 5. In the illustrated embodiment, the method 150 includes forming (block 152) an anode and a cathode. For example, as previously described, the anode may include a current collector foil and active material disposed on opposing sides of the current collector foil. In some embodiments, the current collector foil includes two layers disposed on opposing sides of a plastic layer. The cathode may be similarly formed, except that the active material of the anode is different than the active material of the cathode, and a material of the current collector foil of the anode is different than a material of the current collector foil of the cathode, as previously described.

The method 150 also includes perforating (block 154) the anode with first holes and the cathode with second holes. As previously described, laser perforation or mechanical drilling may be employed to generate (e.g., perforate) the first holes in the anode and the second holes in the cathode.

The method 150 also includes disposing (block 156) the anode, the cathode, a separator (e.g., porous separator), at least one lithium metal electrode, and an electrolyte in an enclosure. As previously described, the anode, the cathode, and the separator may be would to form a jelly roll in certain embodiments, and the jelly roll may be disposed in the enclosure. In some embodiments, first and second lithium metal electrodes may be disposed in the enclosure along with the jelly roll. In other embodiments, only one lithium metal electrode is disposed in the enclosure along with the jelly roll. The electrolyte may pass through the first and second holes in the anode and the cathode, respectively, to form channels promoting movement of Li+ ions about the enclosure, as described below

The method 150 also includes applying (block 158) a voltage to the at least one lithium metal electrode to initiate a pre-lithiation process. For example, in the pre-lithiation process, the Li+ ions may be disbursed form the at least one lithium metal electrode and move about the enclosure by way of the above-described channels. Further, a redox reaction between the Li+ ions and the anode may transfer active lithium to the anode, which reduces or mitigates initial active lithium loss that otherwise occurs during cycling stages (e.g., early cycling stages) of the battery. The method 150 also includes removing (block 160) the at least one lithium metal electrode from the enclosure (e.g., upon completion of the pre-lithiation process). By way of the method 150 described above, battery performance, stability, energy density, and/or voltage uniformity may be improved at a relatively inexpensive cost (e.g., compared to traditional systems and techniques).

FIG. 13 is a process flow diagram illustrating an embodiment of a method 200 of producing the battery 40 of FIG. 2 via the battery pre-lithiation assembly 140 of FIG. 7 or FIG. 8. In the illustrated embodiment, the method 200 includes forming (block 202) an anode and a cathode. Block 202 in the method 200 of FIG. 13 may be the same as, or similar to, block 152 of the method 150 in FIG. 12, described in greater detail above.

The method 200 also includes coating (block 204) the anode with lithium metal. For example, a first lithium metal coating may be disposed on a first layer of anode active material, and a second lithium metal coating may be disposed on a second layer of anode active material. The method 200 also includes perforating (block 206) the anode with first holes and the cathode with second holes. Block 206 in the method 200 of FIG. 13 may be the same as, or similar to, block 154 in the method 150 of FIG. 12.

The method 200 also includes disposing (block 208) the anode, the cathode, a separator (e.g., porous separator), and an electrolyte in an enclosure. Block 208 of the method 200 of FIG. 13 may be the same as, or similar to, block 156 of the method 150 of FIG. 12, except that the method 200 in FIG. 13 does not include disposing at least one lithium metal electrode separate from the anode and the cathode in the enclosure. Indeed, in the method 200 of FIG. 13, the lithium metal coating on the anode acts as the lithium source for the pre-lithiation process.

The method 200 also includes allowing (block 210) electrolyte aging for a time period (e.g., 1-3 days) to initiate and/or carryout the pre-lithiation process. In certain embodiments of the method 200 of FIG. 13, no voltage need be applied to the lithium metal coating on the anode. Further, unlike the method 150 of FIG. 12, lithium metal need not be removed from the enclosure in certain embodiments of the method 200 of FIG. 13. Indeed, the lithium metal coatings disposed on the anode may be depleted by or during the pre-lithiation process.

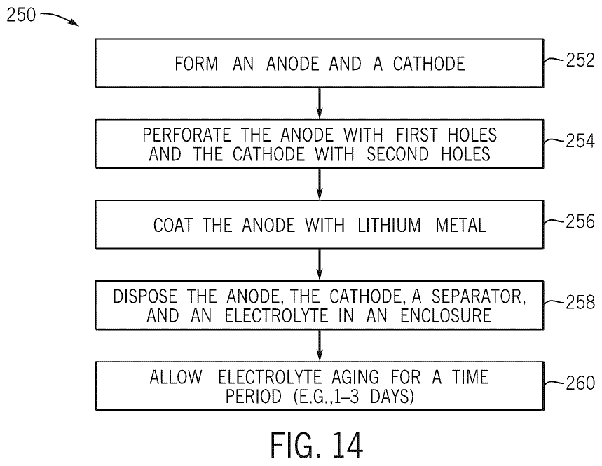

FIG. 14 is a process flow diagram illustrating a method 250 of producing, for example, the battery 40 of FIG. 2 via the battery pre-lithiation assembly 140 of FIG. 7 or FIG. 8, according to embodiments of the present disclosure. In the illustrated embodiment, the method 250 is similar to, or the same as, the method 200 of FIG. 13, except that in the method 250 of FIG. 14, the holes may be disposed in the anode before the lithium metal coatings are disposed on the anode. For example, block 252 in FIG. 14 is the same as (or similar to) block 202 in FIG. 10, block 258 in FIG. 14 is the same as (or similar to) block 208 in FIG. 13, and block 260 in FIG. 14 is the same as (or similar to) block 210 in FIG. 13. However, in FIG. 14, the method 250 may include perforating (block 254) the anode with first holes and the cathode with second holes, and then coating (block 256) the anode with lithium metal. In this way, the lithium metal coatings may react with the anode and the electrolyte and the hole will open by itself after electrolyte injection.

It should be noted that, in the methods 150, 200, and 250 of FIGS. 12, 13, and 14, respectively, the steps (e.g., blocks) may be performed in suitable orders other than those illustrated in FIGS. 12, 13, and 14 and/or described above. Further, other steps and/or techniques (e.g., described in other areas of the present disclosure) may be included in such methods 150, 200. For example, other steps may include electrolyte injection, heating aging, other aspects of jig formation (e.g., where the battery develops solid electrolyte interphase or SEI), degassing the enclosure, etc.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform] ing [a function] . . . ,” it is intended that such elements are to be interpreted under 35 U.S.C. 112 (f). However, for any claims containing elements designated in any other manner, it is intended that such elements are not to be interpreted under 35 U.S.C. 112 (f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A battery pre-lithiation assembly, comprising:
a lithium metal electrode;
an anode comprising a first plurality of holes configured to enable an electrolyte to pass therethrough, and configured to enable movement of Li+ ions associated with the lithium metal electrode during a pre-lithiation process; and
a cathode comprising a second plurality of holes configured to enable the electrolyte to pass therethrough, and configured to enable movement of the Li+ ions associated with the lithium metal electrode during the pre-lithiation process.

2. The battery pre-lithiation assembly of claim 1, wherein:
a first size of each first hole of the first plurality of holes is between 35 and 1000 micrometers; and
a second size of each second hole of the second plurality of holes is between 35 and 1000 micrometers.

3. The battery pre-lithiation assembly of claim 1, comprising a separator disposed between the anode and the cathode, wherein the separator comprises a plurality of pores.

4. The battery pre-lithiation assembly of claim 3, comprising a jelly roll including the anode, the cathode, and the separator.

5. The battery pre-lithiation assembly of claim 1, wherein:
the anode comprises a first layered structure having a first anode active material layer, a second anode active material layer, a first copper layer disposed between the first anode active material layer and the second anode active material layer, a second copper layer disposed between the first anode active material layer and the second anode active material layer, and a first plastic layer disposed between the first copper layer and the second copper layer; and
the cathode comprises a second layered structure having a first cathode active material layer, a second cathode active material layer, a first aluminum layer disposed between the first cathode active material layer and the second cathode active material layer, a second aluminum layer disposed between the first cathode active material layer and the second cathode active material layer, and a second plastic layer disposed between the first aluminum layer and the second aluminum layer.

6. The battery pre-lithiation assembly of claim 1, wherein the anode, the cathode, or both face the lithium metal electrode or a plurality of lithium metal electrodes that include the lithium metal electrode.

7. The battery pre-lithiation assembly of claim 1, comprising an additional lithium metal electrode, wherein:
the anode and the cathode are disposed between the lithium metal electrode and the additional lithium metal electrode;
the first plurality of holes is configured to enable movement of additional Li+ ions associated with the additional lithium metal electrode during the pre-lithiation process; and
the second plurality of holes is configured to enable movement of additional Li+ ions associated with the additional lithium metal electrode during the pre-lithiation process.

8. The battery pre-lithiation assembly of claim 1, wherein the lithium metal electrode is configured to be removed from the battery pre-lithiation assembly after the pre-lithiation process.

9. The battery pre-lithiation assembly of claim 1, wherein the anode comprises a silicon-based active material.

10. The battery pre-lithiation assembly of claim 1, wherein:
the anode comprises a first current collector foil and a first active material coated on the first current collector foil; and
the cathode comprises a second current collector foil and a second active material coated on the second current collector foil.

11. A battery pre-lithiation assembly, comprising:
an anode coated with lithium metal and having a first plurality of holes configured to enable an electrolyte to pass therethrough, and configured to enable movement of Li+ ions associated with the lithium metal during a pre-lithiation process; and
a cathode having a second plurality of holes configured to enable the electrolyte to pass therethrough, and configured to enable movement of the Li+ ions associated with the lithium metal during the pre-lithiation process.

12. The battery pre-lithiation assembly of claim 11, wherein the anode comprises an active material, and the lithium metal is coated on the active material.

13. The battery pre-lithiation assembly of claim 12, wherein the active material comprises silicon.

14. The battery pre-lithiation assembly of claim 11, comprising a separator disposed between the anode and the cathode, wherein the separator comprises a plurality of pores.

15. The battery pre-lithiation assembly of claim 14, comprising a jelly roll including the anode, the cathode, and the separator.

16. The battery pre-lithiation assembly of claim 11, wherein the lithium metal is configured to be depleted during the pre-lithiation process.

17. The battery pre-lithiation assembly of claim 11, wherein:
a first size of each first hole of the first plurality of holes is between 35 and 1000 micrometers; and
a second size of each second hole of the second plurality of holes is between 35 and 1000 micrometers.

18. The battery pre-lithiation assembly of claim 11, wherein:
the anode comprises a first layered structure having a first anode active material layer, a second anode active material layer, a first copper layer disposed between the first anode active material layer and the second anode active material layer, a second copper layer disposed between the first anode active material layer and the second anode active material layer, and a first plastic layer disposed between the first copper layer and the second copper layer; and
the cathode comprises a second layered structure having a first cathode active material layer, a second cathode active material layer, a first aluminum layer disposed between the first cathode active material layer and the second cathode active material layer, a second aluminum layer disposed between the first cathode active material layer and the second cathode active material layer, and a second plastic layer disposed between the first aluminum layer and the second aluminum layer.

19. The battery pre-lithiation assembly of claim 18, wherein the lithium metal is coated on the first anode active material layer and the second anode active material layer.

20. A method of forming a battery cell, comprising:
disposing a lithium metal electrode in an enclosure;
disposing an anode in the enclosure;
disposing a cathode in the enclosure; and
disposing an electrolyte in the enclosure such that the electrolyte passes through a first plurality of holes in the anode and a second plurality of holes in the cathode to form channels enabling movement of Li+ ions within the enclosure and reaction of the Li+ ions with the anode in a pre-lithiation process, wherein the Li+ ions are associated with the lithium metal electrode.

21. The method of claim 20, comprising applying a voltage to the lithium metal electrode to initiate the pre-lithiation process.

22. The method of claim 20, comprising removing the lithium metal electrode from the enclosure after the pre-lithiation process.

23. A method of forming a battery cell, comprising:
coating an anode with lithium metal;
disposing the anode in an enclosure;
disposing a cathode in the enclosure; and
disposing an electrolyte in the enclosure such that the electrolyte passes through a first plurality of holes in the anode and a second plurality of holes in the cathode to form channels enabling movement of Li+ ions within the enclosure and reaction of the Li+ ion with the anode in a pre-lithiation process, wherein the Li+ ions are associated with the lithium metal.
